(19) United States
(12) Patent Application Publication
(10) Pub. No.: US 2007/0267333 A1
(43) Pub. Date: Nov. 22, 2007

(54) WASTE SCOOP

(75) Inventor: Joel G. Delman, Los Angeles, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Aspen Pet Products, Inc., Denver, CO (US)

(21) Appl. No.: 11/733,678

(22) Filed: Apr. 10, 2007

Related U.S. Application Data
(60) Provisional application No. 60/747,583, filed on May 18, 2006.

(51) Int. Cl. B07B 1/49

(52) U.S. Cl. 209/418

(57) ABSTRACT

A waste removal scoop for sifting and removing waste is disclosed herein. The scoop provides a handle and a head coupled to the handle. The head includes a receptacle and a front segment joined to the receptacle. The front segment includes a flexible hinge that flexes as the front segment is pressed against a surface.

### CROSS-REFERENCE TO RELATED APPLICATIONS

This application claims the benefit of U.S. Provisional Patent Application No. 60/747,583, filed May 18, 2006, the disclosure of which is hereby incorporated herein by reference in its entirety.

### FIELD OF THE INVENTION

The present invention relates to scoops for waste removal, and more particularly, to scoops for waste removal with flexible heads.

### BACKGROUND OF THE INVENTION

Scoops for waste removal, such as an animal litter scoop, are well known. These scoops are used to remove waste products or other debris from an animal's litter box. Waste should be removed and separated from litter pellets regularly to ensure a clean environment for the animal. This removal process is typically an undesirable task for a pet owner as it may be messy and unappealing. Accordingly, many scoops have been developed to make this removal process easier and more sanitary for pet owners.

Typical scoops for animal litter boxes are made of hard materials such as plastic and/or metal. These hard materials may withstand the strain users put on them in order to scrape a litter box clean. Users will, at times, add pressure to scrape the box in order to sift the litter or to remove waste product from the litter box. Many scoops are acceptable in design and function if one is to clean a litter box without a litter box liner. However, if the user uses litter box liners to assist in keeping the box clean, then the hard, sometimes sharp scoops may rip and tear the liners. In turn, the rips may result in a mess as dirty litter flows through and collects underneath the litter box liner. These rips in the litter box liner then defeat the entire purpose for such a liner.

There is a need in the art for a waste/debris removal scoop that will not tear litter box liners and will instead easily move across the liner without damaging the liner's integrity.

### BRIEF SUMMARY OF THE INVENTION

One embodiment of the present invention takes the form of a waste removal scoop that may be used for sifting and removing waste. The scoop includes a handle and a head coupled to the handle. The head has a receptacle and a front segment joined to the receptacle. The front segment includes a flexible hinge that flexes as the front segment is pressed against a surface.

Another embodiment of the present invention takes the form of a method of making a waste removal scoop. The method includes forming a handle. The method further includes producing a receptacle extending from one end of the handle, as well as forming a front segment extending from the receptacle. The front segment may include a flexible hinge that flexes as the front segment is pressed against a surface.

As will be realized by those of ordinary skill in the art upon reading the entirety of this disclosure, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a perspective view of a waste scoop.

FIG. 2 is top view of a portion of the scoop.

FIG. 3 is a perspective view of the scoop's front segment with a part of the co-molding removed to illustrate an extension of the front segment.

FIG. 4 is a cross-sectional view of the front segment and receptacle of the scoop.

### DETAILED DESCRIPTION

The present invention discloses a waste removal scoop 10 (such as a litter scoop). The scoop 10 includes a soft edge that flexes when removing waste from a litter box (not shown). The soft edge is further discussed below. The scoop 10 generally allows a user to remove waste from the litter box without ripping or tearing a liner contained therein.

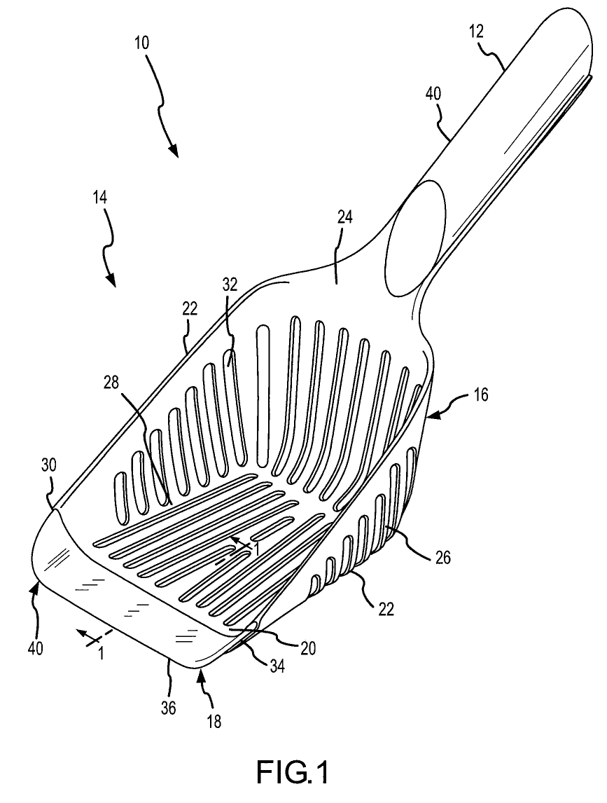

The scoop 10 is now discussed with respect to FIG. 1, which is a perspective view of the scoop 10. In an exemplary embodiment, the scoop 10 includes a handle 12 and a head 14 extending from the handle.

Still referring to FIG.1, the head 14 includes a receptacle 16 and a front segment 18. The front segment 18 may be softer than the receptacle 16. In the exemplary embodiment, the receptacle 16 includes a base 20, sidewalls 22 and a back wall 24. The base 20 includes a back end 26, sides 28, and a front end 30. The sidewalls 22 extend in an upward direction from the sides 28 of the base 20. The back wall 24 extends in an upward direction from the back end 26 of the base 20. Likewise, the front segment 18 extends in a forward direction from the front end 30 of the base 20. The head 14 is preferably slotted with slots or elongated apertures 32 that may be arranged along the sidewalls 22, and/or along the base 20. Additionally, the slots 32 may be arranged along the back wall 24. The slots 32 may permit sifting waste from litter pellets in the litter box.

The majority of the scoop 10, including the handle 12, base 20 and extension 44 (discussed below), is formed from a plastic in the present embodiment.

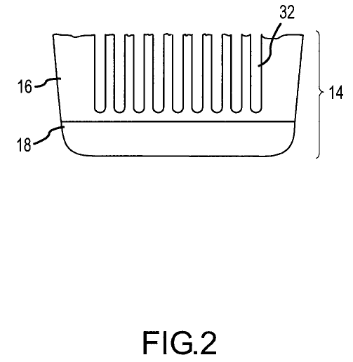

The front segment 18 is shown in FIGS. 2-4. FIG. 2 is a top view of a portion of the exemplary scoop 10 showing the front segment 18, which generally refers to a co-molded, co-extruded or (in certain embodiments) coated portion of the receptacle 16. In the exemplary embodiment, the front segment 18 includes a first end 34 and a second end 36. The first end 34 of the front segment 18 is adjacent the front end 30 of the base 20. A flexible hinge 38 may be formed at the juncture between the first end 34 and base 20. Further, the first end terminates in an edge tip 42.

Still referring to FIGS. 2-4, the flexible hinge 38 may be thinner in the cross section than the receptacle 16 and may be initially molded or formed in this manner with the receptacle. Alternatively, in a multi-step molding process the flexible hinge may be formed by thinning either the extension 44 (discussed below) or receptacle 16. Since the flexible hinge 38 is thinner in cross section than the receptacle 16, the scoop 10 may flex and bend at the hinge. Typically, a material thickness of the receptacle 16 is greater than the material thickness of the flexible hinge 38 to facilitate this flexing.

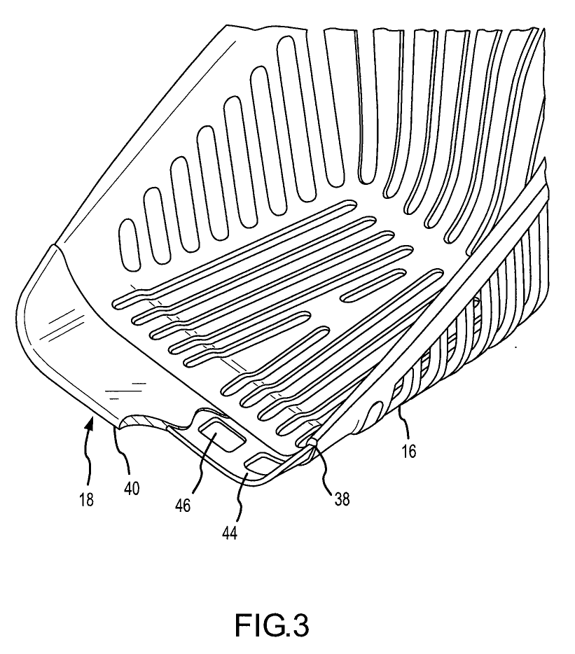

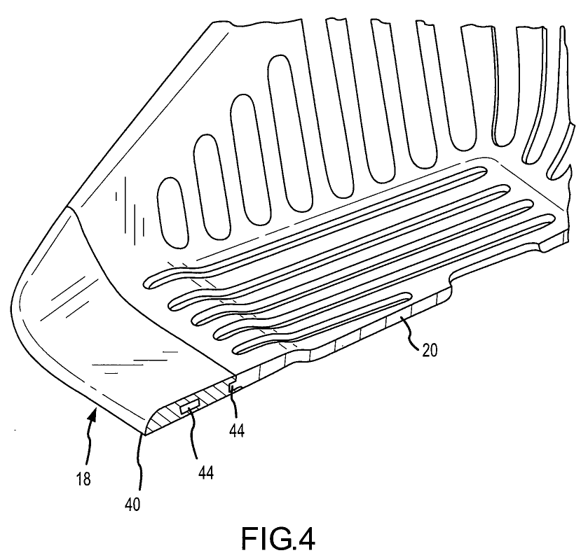

Turning now to FIGS. 3 and 4, an extension 44 may project forward from the flexible hinge 38. The extension 44 may be of approximately the same thickness as the flexible hinge 38 or, in some embodiments, may be somewhat thicker. One or more apertures 46 may be formed in the extension 44. By forming apertures in the extension, the overall flexibility and/or ability of the extension to bend upward or downward along its longitudinal axis may be enhanced as less material may resist this bending. (Generally, the longitudinal axis of the extension 44 and overall scoop 10 is parallel to the handle 12.) The extension is formed of the same material as the scoop base 20 and is typically molded simultaneously with the rest of the scoop 10. Thus, in the present embodiment the extension is unitary with the rest of the scoop 10 and in particular with the scoop base 20, albeit thinner in cross-section as shown particularly in FIG. 4.

Still referring to FIGS. 3 and 4, the front segment 18 (that is, the portion of the scoop 10 forward from the flexible hinge 38) may be formed from not only the extension 44, but a soft elastomeric material 40, such as a polymeric material like a plastic or rubber. In another embodiment, the front segment material may be a silicon material. In still another embodiment, the front segment material may include any material that allows the front segment 18 to slide across the surface of the litter box liner in a smooth manner so as not to tear or rip the liner. Generally, the front segment is not coated with the elastomeric or other front segment material, but instead molded from such material. The front segment material may generally terminate at or about the flexible hinge 38 or first end 34. In particular, the elastomeric material 40 is typically co-molded about and with the extension 44, such that the two materials are pressed in a single mold. (In alternative embodiments, the elastomeric material 44 may be coated or molded about the extension 44 in an operation separate from the molding of the extension itself.) In addition to being generally softer than the extension, the elastomeric material is also typically more flexible. Thus, the co-molded front segment 18 generally flexes and/or bends perpendicularly to the longitudinal axis more easily than a front edge made solely of the material forming the extension 44 and scoop base 20. Additionally, the thickness of the elastomeric material plus the extension is generally equal to a thickness of the receptacle 16.

As shown in the cross-sectional view of FIG. 4, the elastomeric material 40 generally fills in the apertures 46 formed in the extension 44. This creates a stronger bond between the extension 44 and elastomeric material 40 since the elastomeric material may surround at least portions of the extension 44. In addition, since the elastomeric material 40 is typically more flexible than the substance of the extension 44, the flexibility of the front segment 18 is still greater than if it were formed purely from the substance of the extension.

The front segment 18 and receptacle 16 may be molded simultaneously or may be formed in separate stages (in either the same or separate molds). In the present embodiment, the front segment 18 is made by co-molding the elastomeric material 40 over the plastic of the extension 44, rather than simply coated the extension. Thus, the elastomeric material 40 is integrally formed with the receptacle 16 and rest of the scoop. The scoop, including the front segment 18, is generally formed by molding. Thus, the elastomeric material 40 is co-molded with the plastic, resin, polymer or other material used to form the rest of the scoop.

The handle 12 may be co-molded or coated with a material similar to (or the same as) the elastomeric material 40 used to form the front segment 18 of the scoop. For example, the handle 12 may be coated to match the front segment 18 for aesthetics, to impart gliding or other properties similar to those of the front segment, and/or for comfort.

During use, as a user applies pressure to the scoop 10, the scoop 10 travels along the surface of a litter box, and may flex at the flexible hinge 38. Likewise, the sides of the scoop may buckle and bend. The front segment 18 may thus experience some degree of movement with the litter box liner as it slides along the litter box liner. More specifically, the flexible hinge 38 of the scoop 10 allows the head 14 to move as the front segment 18 is pressed into the surface of the litter box. If a litter box liner is pulled over the litter box, the flexible hinge 38 allows some movement if the litter liner shifts, instead of ripping the liner. This movement reduces wear on the litter box liner and works to prevent holes or other ripping.

As previously stated, as pressure is applied to the scoop 10, the flexible front segment 18 bends and the sides 28 of the scoop 10 buckle and bend. The sides 28 and/or base 20 of the scoop 10 may be made of a polymeric material, such as plastic, or other material sufficiently soft to allow this buckling and/or bending.

Although the present invention has been described with reference to certain embodiments and methods of manufacture, persons skilled in the art will recognize that changes may be made in form and detail without departing from the spirit and scope of the invention. Accordingly, the proper scope of the invention is defined by the appended claims.

What is claimed is:

1. A waste removal scoop comprising:
a handle;
a receptacle affixed to the handle;
a front segment joined to the receptacle; and
a flexible hinge of thinner cross-section than the receptacle, the flexible hinge joining the front segment to the receptacle.

2. The waste removal scoop of claim 1, wherein the front segment comprises:
an extension of a first material adjacent the flexible hinge; and
an elastomeric material overlying the extension, the elastomeric material different from the first material.

3. The waste removal scoop of claim 2, wherein:
the extension defines at least one aperture; and
the elastomeric material fills the at least one aperture.

4. The waste removal scoop of claim 2, wherein the elastomeric material and extension are co-molded to form the front segment.

5. The waste removal scoop of claim 4, wherein:
a thickness of the extension is equal to a thickness of the flexible hinge; and
a thickness of the front segment is greater than a thickness of the flexible hinge.

6. The waste removal scoop of claim 4, wherein a thickness of the extension plus the elastomeric material is approximately equal to a thickness of the receptacle.

7. The waste removal scoop of claim 1, wherein:
the receptacle comprises a base and at least one side wall; and
the at least one side wall bends in response to a flexing of the flexible hinge.

8. The waste removal scoop of claim 2, wherein the coating material comprises a polymeric material.

9. The waste removal scoop of claim 2, wherein the coating material comprises a silicon material.

10. A litter scoop comprising:
a handle portion; and
a head coupled the handle portion and having a receptacle and a flexible edge, wherein at least a portion of the flexible edge has a material thickness less than a material thickness of the receptacle.

11. The litter scoop of claim 10, wherein the flexible edge comprises a hinge portion configured to flex as the flexible edge forcibly contacts a surface.

12. The litter scoop of claim 11, wherein the hinge portion connects the flexible edge to the receptacle.

13. The litter scoop of claim 11, wherein the flexible edge comprises:
an extension adjacent the hinge portion; and
an elastomeric material co-molded with the extension.

14. A method of making a waste removal scoop, comprising:
forming a handle;
forming a receptacle extending from one end of the handle; and
forming a front segment extending from the receptacle, wherein the front segment includes a flexible hinge and an extension adjacent the flexible hinge; and
co-molding an elastomeric material about the extension.

15. The method of claim 14, wherein making the front segment further comprises making an edge portion with a material thickness greater than a material thickness of the flexible hinge.

16. The method of claim 14, further comprising:
molding the extension with at least one aperture defined therein; and
the operation of co-molding the elastomeric material about the extension comprises filling the aperture with the elastomeric material.

17. The method of claim 16 wherein the material is configured to allow the front segment to slide in a smooth manner while traveling across a surface.

18. The method of claim 16, wherein the elastomeric material comprises a polymer.

19. The method of claim 16, wherein the elastomeric material comprises a silicon.

20. The method of claim 16, further comprising the operation of coating the handle with the elastomeric material.
